(19) United States
(12) Patent Application Publication
(10) Pub. No.: US 2008/0074703 A1
(43) Pub. Date: Mar. 27, 2008

(54) Engraving cylinder having an end assembly

(76) Inventors: Bruce Knox, Oxon (GB); Philip Millard, Oxford (GB)

Correspondence Address: JACKSON WALKER LLP, 901 MAIN STREET, SUITE 6000, DALLAS, TX, 75202-3797, US

(21) Appl. No.: 11/415,002

(22) Filed: May 1, 2006

(30) Foreign Application Priority Data
Apr. 29, 2005 (GB) GB 0508864.6

(51) Int. Cl. B41C 1/02; G06K 15/00

(52) U.S. Cl. 358/3.29

(57) ABSTRACT

There is described an end assembly for an engraving cylinder for use in a printing medium imaging apparatus, the engraving cylinder having opposite ends and a longitudinal axis extending therebetween, the end assembly comprising: mounting means for mounting said end assembly to one end of the engraving cylinder; engagement means for engaging said apparatus; and adjustment means for adjusting the position of the engagement means relative to the position of the mounting means. There is also described a printing medium imaging apparatus, and an engraving cylinder for use in such a printing medium imaging apparatus, There is also described a method of adjusting the TIR of an engraving cylinder within a printing medium imaging apparatus.

The present invention relates to an engraving cylinder having at least one end assembly, an end assembly for an engraving cylinder, a printing medium imaging apparatus comprising an engraving cylinder having at least one end assembly, and a method of adjusting the TIR of an engraving cylinder within a printing medium imaging apparatus. In particular, but not exclusively, the invention relates to such an engraving cylinder, end assembly, printing medium imaging apparatus and method for use in a laser ablation system.

### DISCUSSION OF THE PRIOR ART

Laser ablation systems have been available for the printing industry for more than twenty-five years. During this period, the reliability of such systems and the quality of print achievable have improved considerably. Furthermore, direct laser ablation continues to be the only truly direct, one-step method of flexo plate and sleeve production, and the only method that eliminates the use of both film and solvents.

FIG. 1 shows an example of a prior art printing medium imaging apparatus 2 for a laser ablation system. The printing medium is used to transfer the ink to the substrate and may comprise a printing plate, a printing screen, a printing sleeve or a printing cylinder. The apparatus 2 is used to image the printing medium.

Before use of the apparatus 2, an engraving cylinder 4 having a first end 6 and a second end 8 is loaded between the headstock 10 and the tailstock 12 of the apparatus 2. The engraving cylinder 4 is preferably loaded in such a way that during use a constant distance is maintained between the laser engraving head 14 and the engraving cylinder 4. During use, the engraving cylinder 4 rotates at high speed and the laser engraving head 14 is able to move back and forth along a line substantially parallel to the longitudinal axis of the engraving cylinder 4. The constant distance between the laser engraving head 14 and the engraving cylinder 4 is preferably maintained within ±20 μm in order to achieve sufficient accuracy in engraving.

The engraving cylinder 4 is loaded into the apparatus 2 by first fully retracting the laser engraving head 14. Then, if necessary, the tailstock 12 is slid aside to allow room for the engraving cylinder 4 to be loaded between the headstock 10 and the tailstock 12. A hoist is generally required to lift the engraving cylinder 4 into place.

The headstock 10 comprises a three-jaw chuck 16 having three self-centring adjustment screws and three individual chuck adjustment screws. The engraving cylinder 4 is mounted in the three-jaw chuck 16 by first opening all three jaws of the three-jaw chuck 16 together using any one of the self-centring screws. The first end 6 of the engraving cylinder 4 comprises an end member adapted to engage the three-jaw chuck 16. The end member is inserted into the jaws of the three-jaw chuck 16. The jaws of the three-jaw chuck 16 are then tightened using the self-centring screws. The individual chuck adjustment screws are not used at this stage.

The tailstock 12 comprises a tailstock member adapted to engage a locating hole in the second end 8 of the engraving cylinder 4. The tailstock member is moved toward the headstock 10 until the tailstock member is inserted a minimum of 4 mm into the locating hole in the second end 8 of the engraving cylinder 4.

Having loaded the engraving cylinder 4 between the headstock 10 and the tailstock 12, the next step in setting up the apparatus 2 is to accurately align the engraving cylinder 4 such that a constant distance is maintained between the laser engraving head 14 and the engraving cylinder 4, as discussed above. The degree of alignment of the engraving cylinder 4 is often referred to as the Total Indicated Runout (TIR).

The laser engraving head 14 is equipped with a focus gauge to measure the distance between the laser engraving head 14 and the engraving cylinder 4. In order to adjust the TIR of the engraving cylinder 4, the laser engraving head 14 is first moved towards the headstock 10 until the focus gauge is approximately 25 mm from the first end 6 of the engraving cylinder 4. A mechanical contact of the focus gauge is then moved such that it touches the engraving cylinder 4. The fine adjustment of the focus gauge is used to give a focus gauge reading of 2.00 mm. This value of 2.00 mm is related to the focal length of the lens in the laser engraving head 14. The engraving cylinder 4 is then rotated through less than one revolution and the individual chuck adjustment screws of the three-jaw chuck 16 are tightened or loosened until the focus gauge reads 2.00 mm to within ±10 μm. This step of rotating the engraving cylinder and adjusting the individual chuck adjustment screws is repeated until the focus gauge reading is constant to within ±10 μm at all rotational positions of the engraving cylinder 4. It will be appreciated that TIR alignment of the engraving cylinder 4 takes up valuable time during which the apparatus 2 cannot be in operation.

The set up time for a laser ablation system is crucial for efficiency in the printing industry. In general, it takes approximately five minutes for a skilled operator to adjust the TIR of a prior art printing medium imaging apparatus as described above, however it may take as long as twenty minutes in some cases.

Due to the time taken to set up an engraving cylinder, users often prefer to use the same engraving cylinder again and again even when it is not an appropriate diameter and/or length for a particular job. In such cases, the area of the engraving plate may be significantly smaller than the surface area of the engraving cylinder, which is an inefficient set up.

Therefore, there is a need for a laser ablation system with a much reduced set up time which is cost effective, versatile and easy to use. In particular, it would be desirable to provide a printing medium imaging apparatus for a laser ablation system which enables the engraving cylinder to be changed quickly by a user without the need to align the TIR of the engraving cylinder every time a new engraving cylinder is loaded. Similarly, it would be desirable to provide a laser ablation system and related components which enable the engraving cylinder to be changed quickly by a user without the need for a hoist. Such a printing medium imaging apparatus would be easy to use and it would be a simple matter for a user to change to an engraving cylinder of an appropriate size for a particular job. Thus, the efficiency of the laser ablation system would be increased. Such a laser ablation system would be particularly useful in the label making industry. The present invention seeks to address these desires.

### SUMMARY OF THE INVENTION

According to a first aspect of the present invention there is provided an engraving cylinder for use in a printing medium imaging apparatus, the engraving cylinder having opposite ends, a longitudinal axis extending between said opposite ends and at least one end assembly, the at least one end assembly comprising mounting means for mounting said end assembly to one end of the engraving cylinder; engagement means for engaging said apparatus; and adjustment means for adjusting the position of the engagement means relative to the position of the mounting means.

Thus, in contrast to the prior art, an engraving cylinder according to the present invention comprises means for adjusting the TIR of the engraving cylinder.

According to a second aspect of the present invention there is provided an end assembly for an engraving cylinder for use in a printing medium imaging apparatus, the engraving cylinder having opposite ends and a longitudinal axis extending therebetween, the end assembly comprising mounting means for mounting said end assembly to one end of the engraving cylinder; engagement means for engaging said apparatus; and adjustment means for adjusting the position of the engagement means relative to the position of the mounting means.

According to a third aspect of the present invention there is provided a printing medium imaging apparatus comprising a headstock; a tailstock; and an engraving cylinder disposed between the headstock and the tailstock, the engraving cylinder having opposite ends, a longitudinal axis extending between said opposite ends and at least one end assembly, the at least one end assembly comprising mounting means for mounting said end assembly to one end of the engraving cylinder; engagement means for engaging said apparatus; and adjustment means for adjusting the position of the engagement means relative to the position of the mounting means.

Advantageously, the adjustment means comprises a first member which is fixed with respect to the longitudinal axis of the engraving cylinder and a second member which is fixed with respect to an axis of rotation of the engraving cylinder, said first and second members being moveable with respect to each other in a plane perpendicular to said longitudinal axis.

Advantageously, the adjustment means comprises a first member which is fixed with respect to said mounting means and a second member which is fixed with respect to said engagement means, said first and second members being moveable with respect to each other in a plane parallel to a radial plane of the engraving cylinder.

Advantageously, one of said first and second members at least partially receives the other.

Advantageously, said first and second members are moveable with respect to each other by means of a plurality of adjustable spacers, the spacers extending from one of said first and second members to abut the other.

More advantageously, said spacers threadingly engage an outer one of said first and second members and are arranged so as to be adjustable in said plane.

Advantageously, said first member is selectively fixed with respect to said second member in an axial direction.

Advantageously, threaded engagement means extend from one of said first and second members in a direction substantially parallel to said axial direction to selectively engage the other of said members and retain said first and second members in a fixed axial spacing.

Advantageously, the end assembly further comprises a cover which overlies the adjustment means.

Advantageously, rotational drive is transmitted to the engraving cylinder through said engagement means.

Advantageously, the engagement means comprises a shaft having a longitudinal axis substantially parallel to the longitudinal axis of the engraving cylinder.

Advantageously, said apparatus comprises a driveshaft, the engagement means being adapted to be uniquely located with respect to said driveshaft.

Advantageously, the engagement means comprises a conical or frustroconical recess having a central axis parallel to the longitudinal axis of the engraving cylinder.

Advantageously, the engraving cylinder is hollow having at least one open end, said mounting means comprising a bung to engage said at least one end. More advantageously, said mounting means is bonded to said at least one end.

Advantageously, the engraving cylinder is formed of material selected from the list comprising carbon fibre, fibreglass and epoxy resin.

Advantageously, said apparatus comprises a printing medium selected from the group consisting of a printing plate, a printing sleeve, a printing screen and a printing cylinder.

According to a fourth aspect of the present invention there is provided a method of adjusting the TIR of an engraving cylinder within a printing medium imaging apparatus comprising the steps of mounting to said apparatus an engraving cylinder having opposite ends, a longitudinal axis extending between said opposite ends and at least one end assembly, said at least one end assembly comprising mounting means for mounting said end assembly to one end of the engraving cylinder, engagement means for engaging said apparatus and adjustment means comprising a first member which is fixed with respect to said mounting means and a second member which is fixed with respect to said engagement means; and moving said first and second members with respect to each other in a plane parallel to a radial plane of the engraving cylinder.

Advantageously, said step of moving said first and second members with respect to each other comprises moving said members such that an axis of rotation of the engraving cylinder is coincident with a point on the longitudinal axis of the engraving cylinder.

Advantageously, the method further comprises the step of fixing said first member in a selected spaced relationship with respect to said second member.

### BRIEF DESCRIPTION OF THE DRAWINGS

An embodiment of the present invention will now be described by way of example with reference to the accompanying drawings in which:

FIG. 1 is a perspective view of a prior art printing medium imaging apparatus with a lid of the apparatus open and the engraving cylinder shown in phantom for the sake of clarity;

FIG. 2 is a perspective view of a printing medium imaging apparatus embodying the present invention with a lid of the apparatus open and the engraving cylinder shown in phantom for the sake of clarity;

FIGS. 3a and 3b are exploded views of a first end assembly 36;

FIGS. 4a and 4b are assembled views of the first end assembly 36;

FIG. 5 is an exploded view of a second end assembly 38; and

FIGS. 6a and 6b are assembled views of the second end assembly 38.

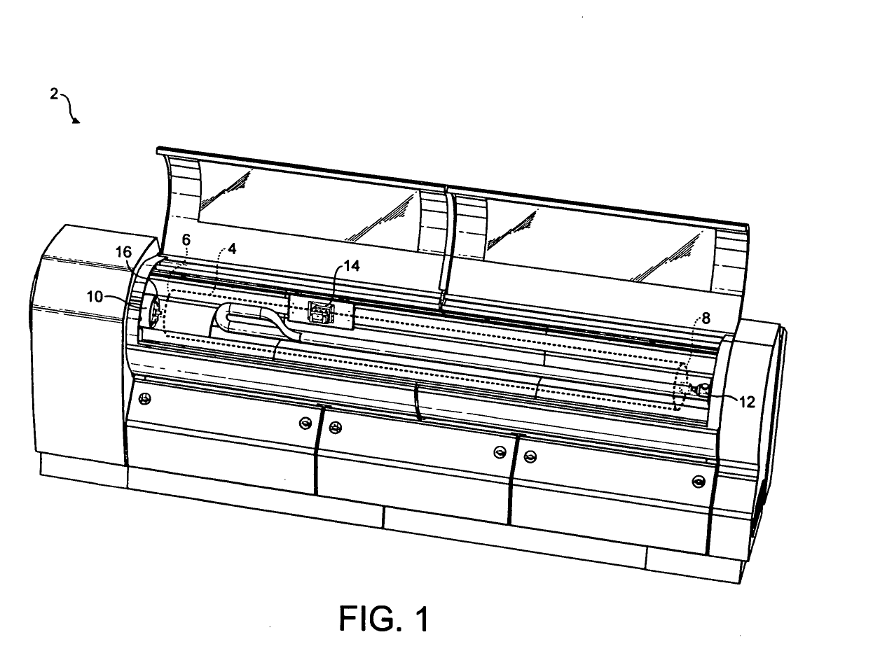

### DETAILED DESCRIPTION OF A PREFERRED EMBODIMENT

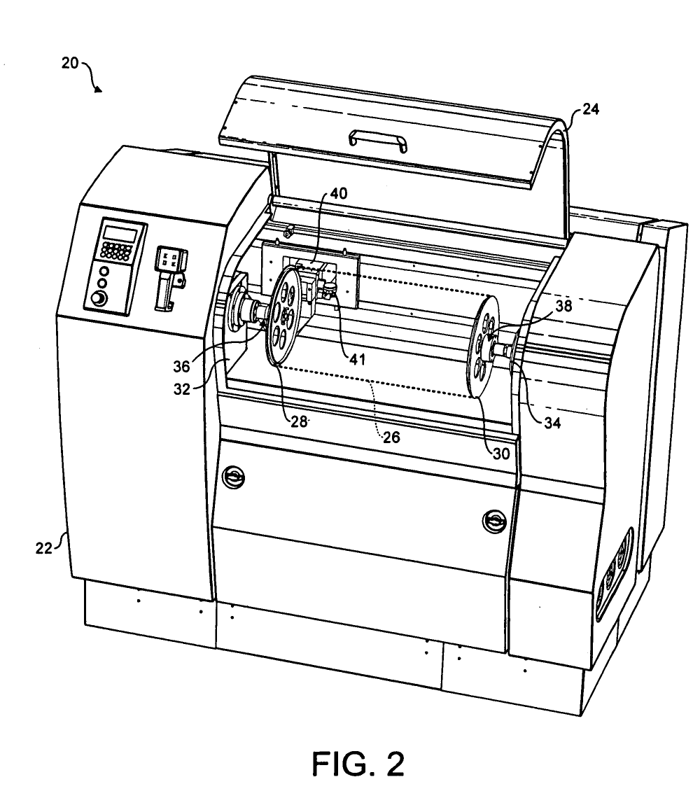

FIG. 2 shows a printing medium imaging apparatus 20 in accordance with one embodiment of the present invention. As for the prior art printing medium imaging apparatus, the printing medium is used to transfer the ink to the substrate and may comprise a printing plate, a printing screen, a printing sleeve or a printing cylinder. The apparatus 20 is used to image the printing medium.

The apparatus 20 comprises a body 22, a lid 24, and an engraving cylinder 26 having a first end 28 and a second end 30. The position of the engraving cylinder 26 is shown by dotted lines in FIG. 2. The engraving cylinder 26 is demountable with respect to the body 22 of the apparatus 20. The lid 26 of the apparatus 20 is closed during operation of the apparatus 20. However the lid 26 of the apparatus 20 may be opened, for example, to load or remove the engraving cylinder 26.

The engraving cylinder 26 preferably has a surface smoothness tolerance of approximately 25 μm. Thus the engraving cylinder 26 is preferably manufactured from a material which enables this tolerance to be achieved. Thus the engraving cylinder 26 may be metallic. Preferably, the engraving cylinder 26 comprises at least one material selected from the group consisting of carbon fibre, fibreglass, and epoxy resin. In this way, it is not normally necessary to use a hoist to support the engraving cylinder 26 as it is loaded into the apparatus 20 as the engraving cylinder 26 is relatively light. Thus the engraving cylinder 26 may be easily loaded into and removed from the apparatus 20.

Furthermore, the engraving cylinder 26 may comprise a mandrel having air holes in the curved cylindrical surface. Thus, when air is forced out through the air holes at high pressure, an air bearing is created to enable a printing sleeve to be fitted that has substantially the same internal diameter as the external diameter of the mandrel.

The body 22 of the apparatus 20 comprises a headstock 32 and a tailstock 34. The engraving cylinder 26 is loaded between the headstock 32 and the tailstock 34. The body 22 of the apparatus 20 further comprises a laser engraving head 40. The laser engraving head 40 is oriented such that the laser is directed towards the cylindrical surface of the engraving cylinder 26 along a line perpendicular to the longitudinal axis of the engraving cylinder 26. In use, the laser engraving head 40 is able to move along a line substantially parallel to the longitudinal axis of the engraving cylinder 26 such that a substantially constant distance is maintained between the laser engraving head 40 and the engraving cylinder 26. The laser engraving head 40 comprises a focus gauge 41 to measure the distance between the laser engraving head 40 and the cylindrical surface of the engraving cylinder 26.

The engraving cylinder 26 comprises a first end assembly 36 on the first end 28 and a second end assembly 38 on the second end 30. The first end assembly 36 of the engraving cylinder 26 engages with the headstock 32 and the second end assembly 38 of the engraving cylinder 26 engages with the tailstock 34. In use, the engraving cylinder 26 is able to rotate at high speed.

The first end assembly 36 comprises mounting means for mounting the first end assembly 36 to the first end 28 of the engraving cylinder 26, engagement means for engaging the headstock 32 of the apparatus 20, and adjustment means for adjusting the position of the engagement means relative to the position of the mounting means.

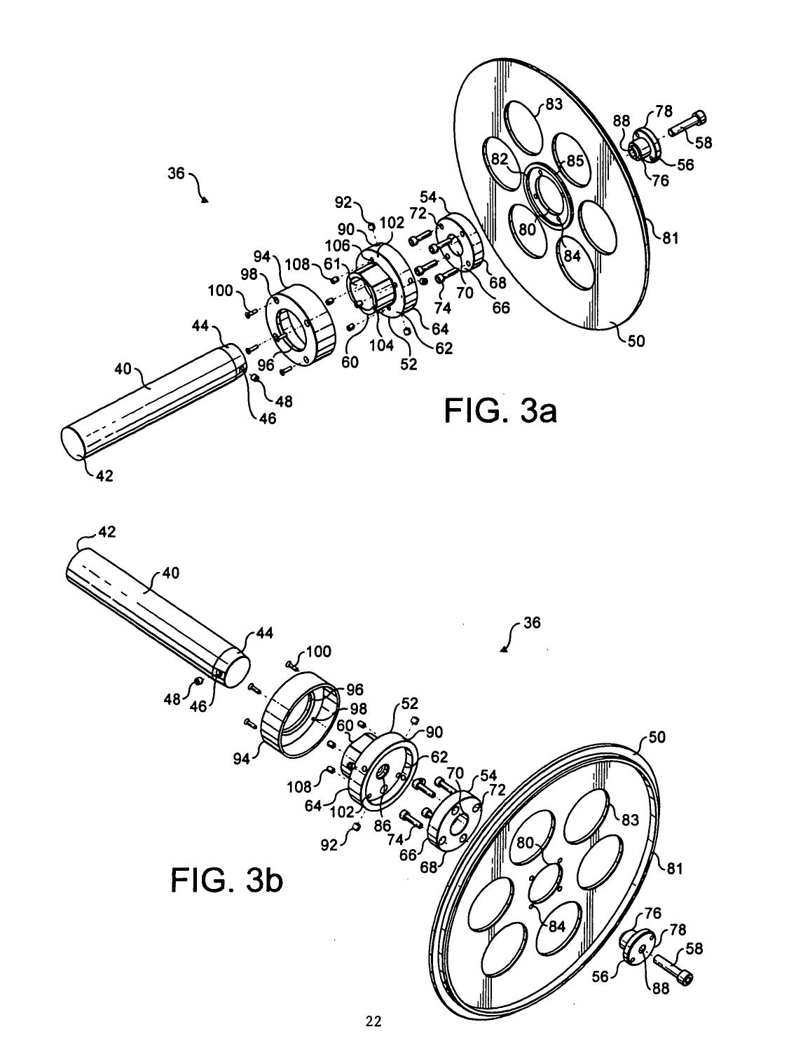

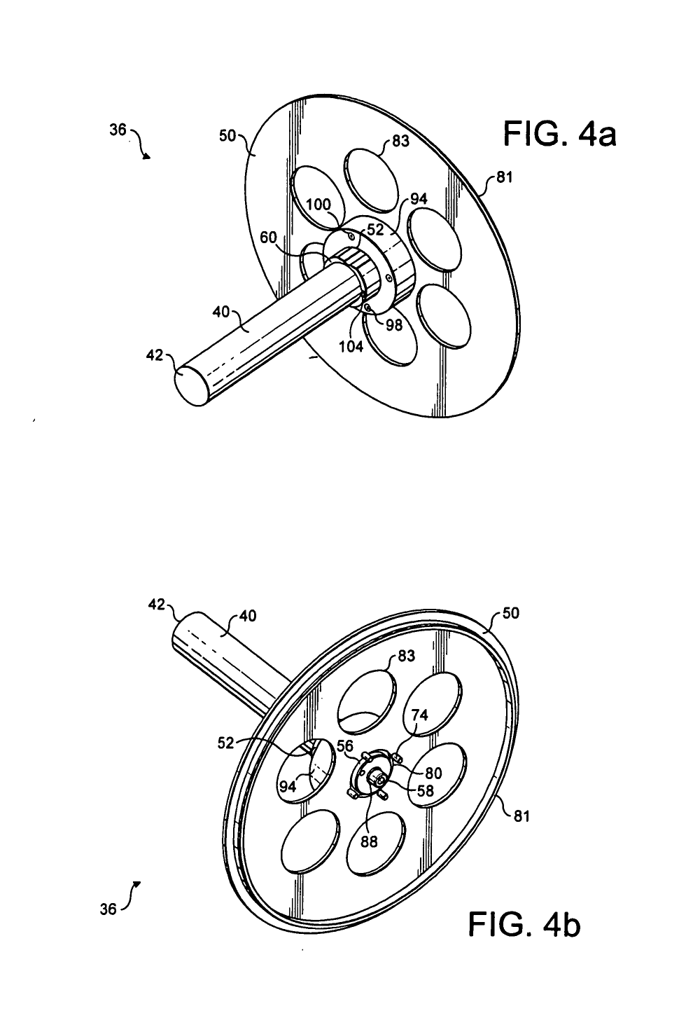

In the arrangement shown in FIGS. 3a to 4b, the engagement means comprises a driveshaft 40.

The driveshaft 40 has a first end 42 and a second end 44, the second end 44 being tapered. The first end 42 of the driveshaft 40 engages with the headstock 32. Preferably, the headstock 32 may comprise a recess adapted to receive the driveshaft 40. In an alternative arrangement, the headstock 32 may comprise a three-jaw chuck into which the driveshaft 40 is inserted. However, a headstock 32 comprising a three-jaw chuck is not essential. Alternatively, a chuck with four or more jaws may be used. In a further alternative arrangement, the driveshaft 40 may be integrally formed with the headstock 32.

In the arrangement shown in FIGS. 3a to 4b, the engraving cylinder 26 is hollow and the mounting means comprises a bung 50.

The bung 50 comprises a central aperture 80, an annular wall 81 and a slip disc recess 82 that are coaxial with a central axis of the bung 50. The central aperture 80 extends through the bung 50. The annular wall 81 is adapted to engage an internal surface of the first end 28 of the engraving cylinder 26. The bung 50 is preferably bonded to the first end 28 of the engraving cylinder 26. The slip disc recess 82 comprises an annular wall 85 and four angularly spaced slip disc screw apertures 84. The annular wall 85 is disposed around the slip disc recess 82. The slip disc screw apertures 84 extend through the bung 50 parallel to a central axis of the bung 50. Each slip disc screw aperture 84 is threaded to receive a respective slip disc screw 74. The bung 50 further comprises six angularly spaced apertures 83 which reduce the weight of the end assembly 36 in order that the engraving cylinder 26 is more easily loaded into the apparatus 20.

It will be appreciated that the bung 50 is not an essential feature of the mounting means. In an alternative arrangement, the bung 50 may be replaced with a cap adapted to engage an external surface of the first end 28 of the engraving cylinder 26. In a further alternative arrangement, the mounting means may be adapted to threadingly engage with the internal or external surface of the first end 28 of the engraving cylinder 26. In a further alternative arrangement, the mounting means may comprises flanges adapted to engage with the first end 28 of the engraving cylinder 26.

Furthermore, it will be appreciated that the six angularly spaced apertures 83 are not an essential feature of the mounting means. Alternatively, there may be a different number of apertures 83, or the apertures 83 may be absent from smaller diameter engraving cylinders since the reduction of weight of the engraving cylinder is less important when the cylinder is already small and light enough to lift easily.

In the arrangement shown in FIGS. 3a to 4b, the adjustment means comprises an adjustment member 52, an annular slip disc 54, a slip disc nut 56, and a slip disc bolt 58.

The annular slip disc 54 comprises a first planar surface 66, an opposing second planar surface 68 and a central aperture 70. The central aperture 70 extends through the slip disc 54 and is coaxial with the central axis of the slip disc 54. The diameter of the slip disc 54 enables the slip disc 54 to be received within the slip disc recess 82 of the bung 50. The slip disc 54 further comprises four angularly spaced slip disc screw apertures 72 which extend through the slip disc 54 parallel to the axis of the slip disc 54. Each slip disc screw aperture 72 is adapted to receive a respective slip disc screw 74. The locations of the slip disc screw apertures 72 relative to the axis of the slip disc 54 correspond to the locations of the slip disc screw apertures 84 relative to the axis of the bung 50. Accordingly, in order to attach the slip disc 54 to the bung 50, each slip disc screw 74 is received within with a respective slip disc screw aperture 72 and is threadingly engaged with a respective slip disc screw aperture 84. After the slip disc screws 74 have been fully screwed into their respective slip disc screw apertures 72 and 84, the heads of the slip disc screws 74 are flush with the first planar surface of the slip disc. It will be appreciated that a different number of slip disc screws 74 and slip disc screw apertures 72 and 84 could be used for this purpose. Alternatively, the slip disc 54 could be integrally formed with the bung 50.

The slip disc nut 56 comprises a first portion 76 having a first diameter and a second portion 78 having a second diameter, the second diameter being larger than the first diameter. The slip disc nut 56 further comprises a central aperture 88. The first portion 76 of the slip disc nut 56 is substantially cylindrical having an external diameter approximately 2 mm smaller than the diameter of the central aperture 70 of the slip disc 54. The axial length of the first portion 76 of the slip disc nut 56 is substantially similar to the axial dimension of the slip disc 54 (i.e. the distance between the first planar surface 66 and the second planar surface 68 of the slip disc 54). The second portion 78 of the slip disc nut 56 acts as a flange to abut the second planar surface 68 of the slip disc 54. The central aperture 88 extends through the slip disc nut 56 and is coaxial with a central axis of the slip disc nut 56. The central aperture 88 is adapted to receive the slip disc bolt 58.

The adjustment member 52 comprises a central disc 62, a first annular wall 60 extending from one side of the central disc 62, and a second annular wall 64 extending from the other side of the central disc 62.

The central disc 62 of the adjustment member 52 comprises a central aperture 86. The central aperture 86 extends through the central disc 62 and is coaxial with a central axis of the central disc 62. The central aperture 86 is threaded to receive the slip disc bolt 58. The central disc 62 of the adjustment member 52 further comprises four angularly spaced locking screw apertures 106 which extend through the central disc 62 parallel to the central axis of the central disc 62. Each locking screw aperture 106 is threaded to receive a respective locking screw 108. It will be appreciated that a different number of locking screws 108 and locking screw apertures 106 could be used.

The first annular wall 60 of the adjustment member 52 has an internal surface 61 which is tapered such that the first annular wall 60 is adapted to receive and closely engage the second end 44 of the driveshaft 40. The second end 44 of the driveshaft 40 comprises a location pin recess 46. The location pin recess 46 is radially disposed within the driveshaft 40 for receiving a location pin 48. The first annular wall 60 of the adjustment member 52 comprises a groove 104 adapted to receive the location pin 48. Thus the receipt of the location pin 48 within the groove 104 and the tapered internal surface 61 together ensure that the second end 44 of the driveshaft 40 is uniquely located with respect to the first end 52 of the adjustment member 50. Furthermore, during the acceleration and deceleration of the engraving cylinder 26, the receipt of the location pin 48 within the groove 104 ensures that the adjustment member 52 cannot rotate relative to the driveshaft 40.

The second annular wall 64 of the adjustment member 52 has an internal diameter larger than the external diameter of the slip disc 54. Preferably, the internal diameter of the second annular wall 64 of the adjustment member 52 is approximately 2 mm larger than the external diameter of the slip disc 54.

In use, the slip disc 54 is located within the annular space defined by the central disc 62 of the adjustment member 52, the second annular wall 64 of the adjustment member 52, and the slip disc nut 56. The slip disc bolt 58 is then threadingly engaged with the slip disc nut 56 and the central disc 62 of the adjustment member 52 such that the slip disc 54 cannot move axially with respect to the adjustment member 52. Thus, the second annular wall 64 of the adjustment member 52, the first portion 76 of the slip disc nut 56, and the slip disc bolt 58 are positioned substantially concentrically. The axial dimension of the slip disc 54 is such that the slip disc 54 protrudes axially from within the second annular wall 64 and is received within the slip disc recess 82.

The second annular wall 64 of the adjustment member 52 further comprises four circumferentially spaced adjustment screw apertures 90 which extend radially through the second annular wall 64 of the adjustment member 52. Each adjustment screw aperture 90 is threaded to receive a respective adjustment screw 92. In use, each adjustment screw 92 engages with a respective point on the curved outer surface of the slip disc 54. The adjustment screws 92 are used to adjust the position of the slip disc 54 relative to the position of the adjustment member 52 in a plane perpendicular to a central axis of the adjustment member 52. In this way it is possible to render coincident the longitudinal axis of the engraving cylinder 26 and the longitudinal axis of the driveshaft 40. Thus, the adjustment screws 92 are used to adjust the TIR of the engraving cylinder 26.

In the arrangement shown in FIGS. 3a to 4b, the first end assembly 36 further comprises a cover 94. The cover 94 is adapted to fit over the adjustment member 52 such that the first annular wall 60 of the adjustment member 52 extends through a central aperture 96 of the cover 94. The cover 94 comprises four angularly spaced cover screw apertures 98 which extend through the cover 94 and parallel to a central axis of the cover 94. Each cover screw aperture 98 is adapted to receive a respective cover screw 100. In order to attach the cover 94 to the adjustment member 52, each cover screw 100 is received within a respective cover screw aperture 98 and is threadingly engaged with a respective cover screw aperture 102. It will be appreciated that the cover 94 is not an essential element of the invention. Nonetheless, preferably the first end assembly 36 comprises a cover 94 in order to prevent accidental adjustments of the set up of the first end assembly 36. More preferably, the cover 94 cannot be easily removed once the TIR of the engraving cylinder 26 has been aligned using the adjustment screws 92 as described above. For example, engagement of the cover screws 100 may require the use of a specially shaped tool.

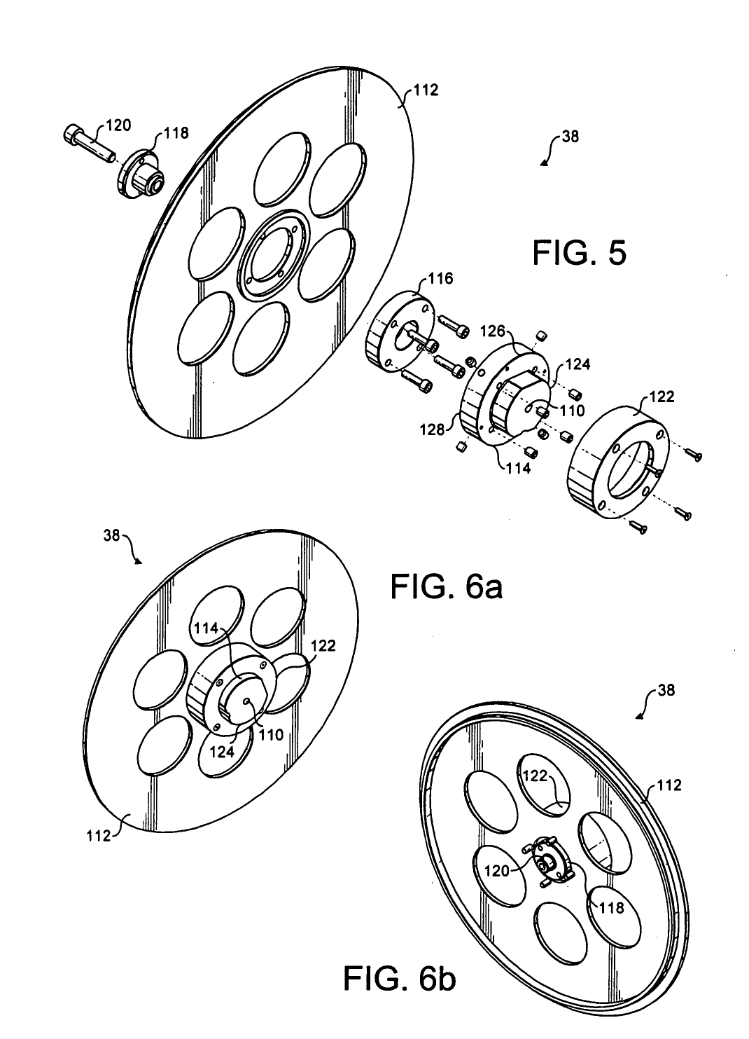

FIG. 5 is an exploded view of the second end assembly 38. FIGS. 6a and 6b are assembled views of the second end assembly 38.

The second end assembly 38 comprises mounting means for mounting the second end assembly 38 to the second end 30 of the engraving cylinder 26, engagement means for engaging the apparatus 20, and adjustment means for adjusting the position of the engagement means relative to the position of the mounting means.

In the arrangement shown in FIGS. 5, 6a and 6b, the engraving cylinder 26 is hollow and the mounting means is a bung 112. The bung 112 of the second end assembly 38 is identical to the bung 50 of the first end assembly 36. However, it will be appreciated that it is not essential that the bung 112 is identical to the bung 50.

In the arrangement shown in FIGS. 5, 6a and 6b, the adjustment means comprises an adjustment member 114, a slip disc 116, a slip disc nut 118, and a slip disc bolt 120. The slip disc 116, the slip disc nut 118, and the slip disc bolt 120 of the second end assembly 38 are identical to the respective slip disc 52, slip disc nut 56, and slip disc bolt 58 of the first end assembly 36. However, it will again be appreciated that this need not necessarily be the case.

In the arrangement shown in FIGS. 5, 6a and 6b, the adjustment member 114 comprises a central disc 126, a substantially cylindrical portion 124 extending from one side of the central disc 126, and an annular wall 128 extending from the other side of the central disc 126. The central disc 126 and the annular wall 128 of the adjustment member 114 of the second end assembly 38 are identical to the respective central disc 62 and second annular wall 64 of the adjustment member 52 of the first end assembly 36. The cylindrical portion 124 of the adjustment member 114 of the second end assembly 38 has closed opposing ends. The closed end remote from the central disc 126 comprises a substantially conical central recess 110 having an axis parallel to the axis of the engraving cylinder 26.

In the arrangement shown in FIGS. 5, 6a and 6b, the engagement means comprises the substantially conical central recess 110. Thus, in this arrangement, the engagement means is integrally formed with the substantially cylindrical portion 124 of the adjustment member 114. The substantially conical central recess 110 engages with the tailstock 34. The tailstock 34 comprises an engagement member adapted to engage with the substantially conical central recess 110.

In the arrangement shown in FIGS. 5, 6a and 6b, the second end assembly 38 further comprises a cover 122. The cover 122 of the second end assembly 38 is identical to the cover 94 of the first end assembly 36.

A difference between the first end assembly 36 and the second end assembly 38 is that the driveshaft 40 of the first end assembly 36 enables the apparatus 20 to drive the rotation of the engraving cylinder 26. In the preferred arrangement shown in FIG. 2, the engraving cylinder 26 comprises a first end assembly 36 having the arrangement shown in FIGS. 3a to 4b and a second end assembly 38 having the arrangement shown in FIGS. 5 to 6b. Alternatively, an engraving cylinder could comprise two end assemblies having the arrangement of the first end assembly 36 shown in FIGS. 3a to 4b. Alternatively again, an engraving cylinder could comprise one end assemblies having the arrangement of the first end assembly 36 shown in FIGS. 3a to 4b and one prior art end assembly without adjustment means.

The method of setting up the engraving cylinder 26 before use for the first time is described below. It will be appreciated that some of the steps in the set up process described below could be performed in a different order.

The first end assembly 36 is assembled by first securely attaching the slip disc 54 to the bung 50 using the slip disc screws 74. The second annular wall 64 of the adjustment member 52 is positioned around the slip disc 54 and is held in a fixed axial position using the slip disc nut 56 and the slip disc bolt 58. The bung 50 is secured to the first end 28 of the engraving cylinder 26. Preferably, the bung 50 is bonded into the first end 28 of the engraving cylinder 26. The second end 44 of the driveshaft 40 is received within the first annular wall 60 of the adjustment member 52 with the location pin 48 received within the groove 104. The engraving cylinder 26 is then loaded between the headstock 32 and the tailstock 34 of the apparatus 20. The next step is to adjust the TIR of the engraving cylinder 26 such that a constant distance is maintained between the laser engraving head 40 and the engraving cylinder 26, as described below.

The laser engraving head 40 is first moved towards the headstock 32 until the focus gauge 41 is approximately 25 mm from the first end 28 of the engraving cylinder 26. The mechanical contact of the focus gauge 41 is then moved such that it touches the cylindrical surface of the engraving cylinder 26. The fine adjustment of the focus gauge 41 is used to give a focus gauge reading of 2.00 mm. It will be appreciated the appropriate gauge reading may range from about 1.00 mm to about 6.00 mm depending on the focal length of the lens in the laser engraving head 40. Nonetheless, this embodiment is described with reference to a value of 2.00 mm. The engraving cylinder 26 is then rotated through less than one revolution and the adjustment screws 92 are tightened or loosened until the focus gauge 41 reads 2.00 mm to within ±10 μm. This step of rotating the engraving cylinder 26 and adjusting the adjustment screws 92 is repeated until the focus gauge reading is constant to within ±10 μm at all rotational positions of the engraving cylinder 26. After the engraving cylinder 26 has been aligned in this way, the locking screws 108 are tightened so as to engage with the first planar surface 66 of the slip disc 54. Thus, the TIR adjustment settings of the first end assembly are secured against possible movement during operation of the apparatus 20.

The TIR adjustment settings are therefore retained by the first end assembly 36 of the engraving cylinder 26 and will be the same whenever that engraving cylinder 26 is mounted in the headstock 32. Thus, after the engraving cylinder 26 has been aligned once as described above, there is no need to realign the engraving cylinder 26 when it is next used since the TIR adjustment settings are retained by the first end assembly 36. For example, even if the engraving 20 cylinder 26 is removed from the apparatus 20 to enable the use of a second engraving cylinder, there will be no need to realign the first engraving cylinder 26 when it is replaced in the apparatus 20. In contrast, the TIR must be adjusted on the headstock every time a prior art engraving cylinder is loaded in the printing medium imaging apparatus.

In the arrangements shown in FIGS. 3a to 6b, the adjustment means comprises a first 25 member which is fixed relative to the engraving cylinder (i.e. the slip discs 54, 116) and a second member which is fixed relative to the printing medium imaging apparatus (i.e. the adjustment member 52, 114), the first member capturing the second member. However, in an alternative arrangement, the second member could capture the first member.

1. An end assembly for an engraving cylinder for use in a printing medium imaging apparatus, the engraving cylinder having opposite ends and a longitudinal axis extending therebetween, the end assembly comprising:
mounting means for mounting said end assembly to one end of the engraving cylinder;
engagement means for engaging said apparatus; and
adjustment means for adjusting the position of the engagement means relative to the position of the mounting means.

2. The invention of claim 1, wherein the adjustment means comprises a first member which is fixed with respect to the longitudinal axis of the engraving cylinder and a second member which is fixed with respect to an axis of rotation of the engraving cylinder, said first and second members being moveable with respect to each other in a plane perpendicular to said longitudinal axis.

3. The invention of claim 1, wherein the adjustment means comprises a first member which is fixed with respect to said mounting means and a second member which is fixed with respect to said engagement means, said first and second members being moveable with respect to each other in a plane parallel to a radial plane of the engraving cylinder.

4. The invention of claim 2, wherein one of said first and second members at least partially receives the other.

5. The invention of claim 4, wherein said first and second members are moveable with respect to each other by means of a plurality of adjustable spacers, the spacers extending from one of said first and second members to abut the other.

6. The invention of claim 5, wherein said spacers threadingly engage an outer one of said first and second members and are arranged so as to be adjustable in said plane.

7. The invention of claim 2, wherein said first member is selectively fixed with respect to said second member in an axial direction.

8. The invention of claim 7, wherein threaded engagement means extend from one of said first and second members in a direction substantially parallel to said axial direction to selectively engage the other of said members and retain said first and second members in a fixed axial spacing.

9. The invention of claim 1, wherein the end assembly further comprises a cover which overlies the adjustment means.

10. The invention of claim 1, wherein rotational drive is transmitted to the engraving cylinder through said engagement means.

11. The invention of claim 1, wherein the engagement means comprises a shaft having a longitudinal axis substantially parallel to the longitudinal axis of the engraving cylinder.

12. The invention of claim 1, wherein said apparatus comprises a driveshaft, the engagement means being adapted to be uniquely located with respect to said driveshaft.

13. The invention of claim 1, wherein the engagement means comprises a conical or frustroconical recess having a central axis parallel to the longitudinal axis of the engraving cylinder.

14. The invention of claim 1, wherein the engraving cylinder is hollow having at least one open end, said mounting means comprising a bung to engage said at least one end.

15. The invention claim 14, wherein said mounting means is bonded to said at least one end.

16. The invention of claim 1, wherein the engraving cylinder is formed of material selected from the list comprising carbon fibre, fibreglass and epoxy resin.

17. The invention of claim 1, wherein said apparatus comprises a printing medium selected from the group consisting of a printing plate, a printing sleeve, a printing screen and a printing cylinder.

18. An engraving cylinder for use in a printing medium imaging apparatus, the engraving cylinder having opposite ends, a longitudinal axis extending between said opposite ends and at least one end assembly, the at least one end assembly comprising:
mounting means for mounting said end assembly to one end of the engraving cylinder;
engagement means for engaging said apparatus; and
adjustment means for adjusting the position of the engagement means relative to the position of the mounting means.

19. A printing medium imaging apparatus comprising:
a headstock;
a tailstock; and
an engraving cylinder disposed between the headstock and the tailstock, the engraving cylinder having opposite ends, a longitudinal axis extending between said opposite ends and at least one end assembly, the at least one end assembly comprising:
mounting means for mounting said end assembly to one end of the engraving cylinder;
engagement means for engaging said apparatus; and
adjustment means for adjusting the position of the engagement means relative to the position of the mounting means.

20. A method of adjusting the TIR of an engraving cylinder within a printing medium imaging apparatus comprising the steps of:
mounting to said apparatus an engraving cylinder having opposite ends, a longitudinal axis extending between said opposite ends and at least one end assembly, said at least one end assembly comprising mounting means for mounting said end assembly to one end of the engraving cylinder, engagement means for engaging said apparatus and adjustment means comprising a first member which is fixed with respect to said mounting means and a second member which is fixed with respect to said engagement means; and
moving said first and second members with respect to each other in a plane parallel to a radial plane of the engraving cylinder.

21. The method of claim 20, wherein said step of moving said first and second members with respect to each other comprises moving said members such that an axis of rotation of the engraving cylinder is coincident with a point on the longitudinal axis of the engraving cylinder.

22. The method of claim 20, wherein the method further comprises the step of fixing said first member in a selected spaced relationship with respect to said second member.
